(19) United States
(12) Patent Application Publication
(10) Pub. No.: US 2021/0224947 A1
(43) Pub. Date: Jul. 22, 2021

(54) Computer Vision Systems and Methods for Diverse Image-to-Image Translation Via Disentangled Representations

(71) Applicant: Insurance Services Office, Inc., Jersey City, NJ (US)

(72) Inventors: Hsin-Ying Lee, Merced, CA (US); Hung-Yu Tseng, Santa Clara, CA (US); Jia-Bin Huang, Blacksburg, VA (US); Maneesh Kumar Singh, Lawrenceville, NJ (US); Ming-Hsuan Yang, Sunnyvale, CA (US)

(73) Assignee: Insurance Services Office, Inc., Jersey City, NJ (US)

(21) Appl. No.: 17/152,491

(22) Filed: Jan. 19, 2021

Related U.S. Application Data
(60) Provisional application No. 62/962,376, filed on Jan. 17, 2020.
(60) Provisional application No. 62/991,271, filed on Mar. 18, 2020.

(51) Int. Cl. G06T 3/20; G06T 7/00

(52) U.S. Cl. CPC G06T 3/20; G06T 2207/20081; G06T 2207/20084; G06T 7/97

(57) ABSTRACT

Computer vision systems and methods for image to image translation are provided. The system receives a first input image and a second input image and applies a content adversarial loss function to the first input image and the second input image to determine a disentanglement representation of the first input image and a disentanglement representation of the second input image. The system trains a network to generate at least one output image by applying a cross cycle consistency loss function to the first disentanglement representation and the second disentanglement representation to perform multimodal mapping between the first input image and the second input image.

### RELATED APPLICATIONS

This application claims priority to U.S. Provisional Patent Application Ser. No. 62/962,376 filed on Jan. 17, 2020 and U.S. Provisional patent Application Ser. No. 62/991,271 filed on Mar. 18, 2020, each of which is hereby expressly incorporated by reference.

### BACKGROUND

### Technical Field

The present disclosure relates generally to the field of image analysis and processing. More specifically, the present disclosure relates to computer vision systems and methods for diverse image-to-image translation via disentangled representations.

### Related Art

In the computer vision fields, image-to-image (“I2I”) translation aims to enable computers to learn the mapping between different visual domains. Many vision and graphics problems can be formulated as I2I problems, such as colorization (e.g., grayscale to color), super-resolution (e.g., low-resolution to high resolution), and photo-realistic image rendering (e.g., label to image). Furthermore, I2I translation has recently shown promising results in facilitating domain adaptation.

In existing computer visions systems, learning the mapping between two visual domains is challenging for two main reasons. First, corresponding training image pairs are either difficult to collect (e.g., day scene and night scene) or do not exist (e.g., artwork and real photos). Second, many of such mappings are inherently multimodal (e.g., a single input may correspond to multiple possible outputs). To handle multimodal translation, low-dimensional latent vectors are commonly used along with input images to model the distribution of the target domain. However, mode collapse can still occur easily since the generator often ignores additional latent vectors.

Several efforts have been made to address these issues. In a first example, the “Pix2pix” system applies a conditional generative adversarial network to I2I translation problems. However, the training process requires paired data. In a second example, the “CycleGAN” and “UNIT” systems relax the dependence on paired training data. These methods, however, produce a single output conditioned on the given input image. Further, simply incorporating noise vectors as additional inputs to the model is still not effective to capture the output distribution due to the mode collapsing issue. The generators in these methods are inclined to overlook the added noise vectors. Recently, the “BicycleGAN” system tackled the problem of generating diverse outputs in I2I problems. Nevertheless, the training process requires paired images.

The computer vision systems and methods disclosed herein solve these and other needs by using a disentangled representation framework for machine learning to generate diverse outputs without paired training datasets. Specifically, the computer vision systems and methods disclosed herein map images onto two disentangled spaces: a shared content space and a domain-specific attribute space.

### SUMMARY

This present disclosure relates to computer vision systems and methods for diverse image-to-image translation via disentangled representations. Specifically, the system first performs a content disentanglement and attribution processing phase, where the system projects input images onto a shared content space and domain-specific attribute spaces. The system then performs a cross-cycle consistency loss processing phase. During the cross-cycle consistency loss processing phase, the system performs a forward translation stage and a backward translation stage. Finally, the system performs a loss functions processing phase. During the loss function processing phase, the system determines an adversarial loss function, a self-reconstruction loss function, a Kullback-Leibler divergence loss (“KL loss”) function and a latent regression loss function. These processing phases allow the system to perform diverse translation between any two collections of digital images without aligned training image pairs, and to perform translation with a given attribute from an example image.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing features of the invention will be apparent from the following Detailed Description of the Invention, taken in connection with the accompanying drawings, in which:

FIG. 1A is a diagram illustrating operation of the system, wherein the system learns to perform diverse translations between two collections of images without requiring aligned training image pairs;

FIG. 1B is a diagram illustrating the system performing translation with a given attribute from an example image;

FIGS. 2A-2C are diagrams illustrating the learning frameworks of the CycleGAN system, the UNIT system, and the system of the present invention;

FIG. 3 is a flowchart illustrating overall process steps carried out by the system of the present disclosure;

FIG. 4 is a flowchart illustrating step 12 of FIG. 3 in greater detail;

FIG. 5 is a flowchart illustrating step 14 of FIG. 3 in greater detail;

FIG. 6 is a flowchart illustrating step 16 of FIG. 3 in greater detail;

FIGS. 7A-7B are diagrams illustrating application of the system of the loss functions of steps 42-48 in the network training process;

FIG. 8A is a diagram illustrating a framework training of the system which processes unpaired images to learn a multimodal mapping between two domains (X and Y) with unpaired data;

FIG. 8B is a diagram illustrating generation by the system of output images conditioned on random attributes;

FIG. 8C is a diagram illustrating generation by the system of output images conditioned on a given attribute;

FIG. 9 is a diagram illustrating sample results produced by the steps 10 carried out by the system;

FIG. 10 is a flowchart illustrating a diversity comparison performed by the system;

FIG. 11 is a diagram illustrating a linear interpolation of attribute vectors performed by the system;

FIG. 12 is a diagram illustrating an attribute transfer carried out by the system on several image-to-image datasets;

FIGS. 13A-13B are diagrams illustrating domain adaptation experiments; and

FIG. 14 is a diagram illustrating sample hardware components on which the system of the present disclosure could be implemented.

### DETAILED DESCRIPTION

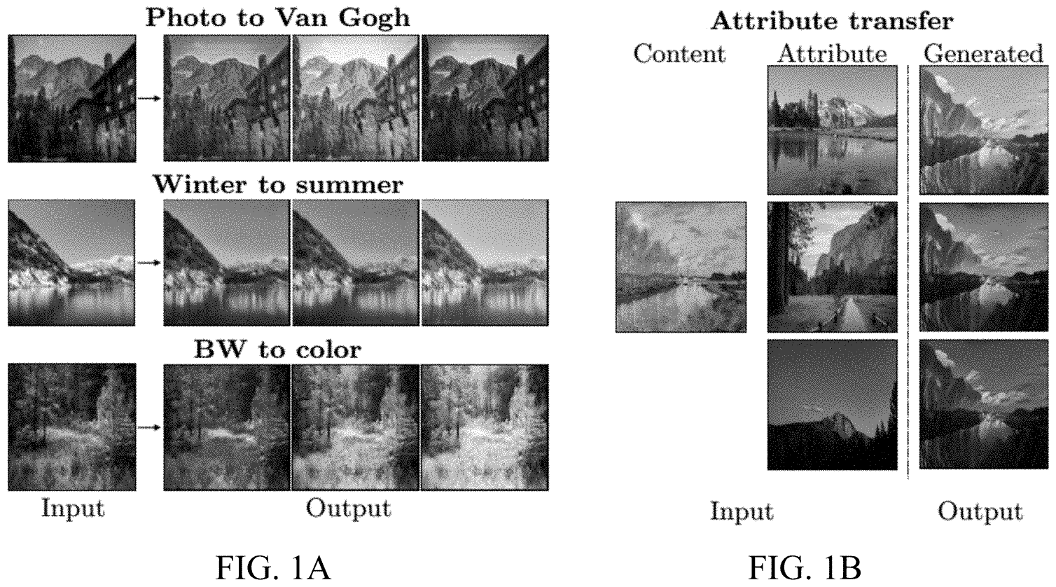

The present disclosure relates to computer vision systems and methods for diverse image-to-image translation via disentangled representations, as described in detail below in connection with FIGS. 1-14.

Specifically, the computer vision systems and methods disclosed herein, map images onto two disentangled spaces: a shared content space and a domain-specific attribute space. A machine learning generator learns to produce outputs using a combination of a content feature and a latent attribute vector. To allow for diverse output generation, the latent vector and the corresponding outputs are invertible and thereby avoid many-to-one mappings. The attribute space encodes domain-specific information while the content space captures information across domains. Representation disentanglement is achieved by applying a content adversarial loss (for encouraging the content features not to carry domain-specific cues) and a reconstruction loss (for modeling the diverse variations within each domain). To handle unpaired datasets, the system and methods disclosed herein use a cross-cycle consistency loss function using the disentangled representations. Given a non-aligned pair, the system performs a cross-domain mapping to obtain intermediate results by swapping the attribute vectors from both images. The system then applies the cross-domain mapping again to recover the original input images. The system can generate diverse outputs using random samples from the attribute space, and provide desired attributes from existing images. More specifically, the system translates one type of image (e.g., an input image) into one or more different output images using a machine learning architecture.

FIG. 1A is an illustration showing the system learning to perform diverse translation between two collections of images without aligned training image pairs. Specifically, in the first row of FIG. 1A, an input image having real world setting is translated into three output images having Van Gogh styles. In the second row of FIG. 1A, an input image having a winter setting is translated into three output images having summer settings. In the third row of FIG. 1A, a black and white input image is translated into three output color images.

FIG. 1B is an illustration showing the system performing translation with a given attribute from an example image. For example, a content image (e.g., input image) of a river and trees in a rustic setting is provided. In the first row of FIG. 1B, an image with a spring setting is used as an attribute image, and the content image is translated into a generated image (e.g., output image) which includes the attributes of the spring setting. In the second row of FIG. 1B, an image with a dusk setting is used as the attribute image, and the content image is translated into a generated image which includes the attributes of the dusk setting. In the third row of FIG. 1B, an image with a evening setting is used as the attribute image, and the content image is translated into a generated image which includes the attributes of the evening setting.

It should also be noted that the computer vision systems and methods disclosed herein provide a significant technological improvement over existing mapping and translation models. In prior art systems such as a generative adversarial network (“GAN”) system used for image generation, the core feature of the GAN system lies in the adversarial loss that enforces the distribution of generated images to match that of the target domain. However, many existing GAN system frameworks require paired training data. The system of the present disclosure produces diverse outputs without requiring any paired data, thus having wider applicability to problems where paired datasets are scarce or not available, thereby improving computer image processing and vision systems. Further, to train with unpaired data, frameworks such as CycleGAN, DiscoGAN, and UNIT systems leverage cycle consistency to regularize the training. These methods all perform deterministic generation conditioned on an input image alone, thus producing only a single output. The system of the present disclosure, on the other hand, enables image-to-image translation with multiple outputs given a certain content in the absence of paired data.

Even further, the task of disentangled representation focuses on modeling different factors of data variation with separated latent vectors. Previous work leverages labeled data to factorize representations into class-related and class-independent representations. The system of the present disclosure models image-to-image translations as adapting domain-specific attributes while preserving domain-invariant information. Further, the system of the present disclosure disentangles latent representations into domain-invariant content representations and domain-specific attribute representations. This is achieved by applying content adversarial loss on encoders to disentangle domain-invariant and domain specific features.

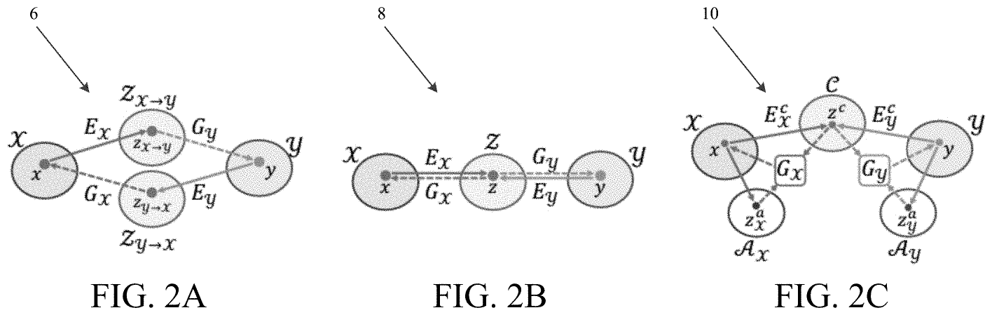

FIGS. 2A-2C are diagrams illustrating the frameworks of the CycleGAN system 6, the UNIT system 8 and the system of the present disclosure 10, respectively. As seen in FIGS. 2A-2C, denoting x and y as images in domain X and Y, the CycleGAN system 6 maps x and y onto separated latent spaces, the UNIT system 8 assumes x and y can be mapped onto a shared latent space, and the system of the present invention 10 disentangles the latent spaces of x and y into a shared content space C and an attribute space A of each domain.

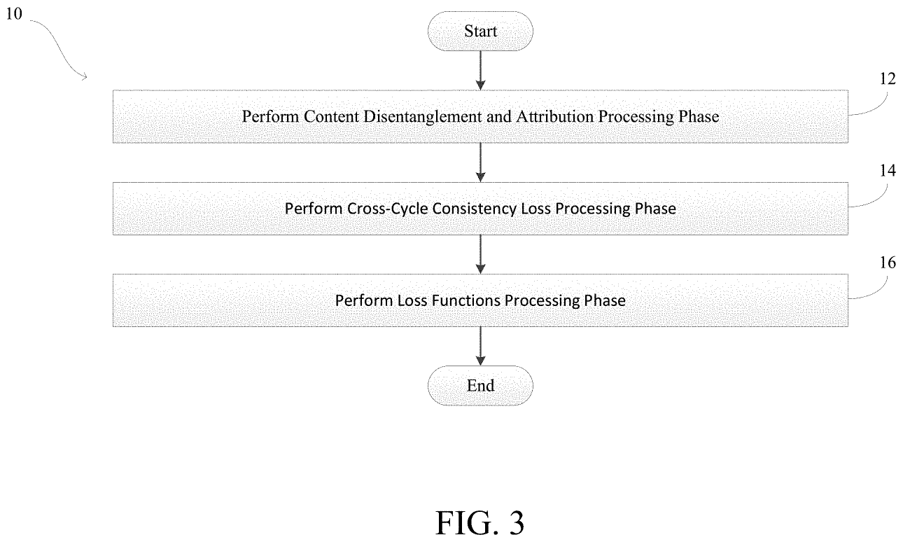

FIG. 3 is a flowchart illustrating the overall process steps carried out by the system of the present disclosure, indicated generally at method 10. In step 12, the system performs a content disentanglement and attribution processing phase. Specifically, in step 12, the system projects the spaces Aₓ and A_{y} input images onto a shared content space C, and domain specific attribute spaces Aₓ and A_{y}. The spaces Aₓ and A_{y}, and C could be stored in computer memory. In step 14, the system performs a cross-cycle consistency loss processing phase. In step 16, the system 10 performs a loss functions processing phase. Each step of FIG. 3 will be described in greater detail below.

It should be understood that FIG. 3 is only one potential configuration, and the system of the present disclosure can be implemented using a number of different configurations. The process steps of the systems and methods disclosed herein could be embodied as computer-readable software code executed by one or more computer systems, and could be programmed using any suitable programming languages including, but not limited to, C, C++, C#, Java, Python or any other suitable language. Additionally, the computer system(s) on which the present disclosure could be implemented includes, but is not limited to, one or more personal computers, servers, mobile devices, cloud-based computing platforms, etc., each having one or more suitably powerful microprocessors and associated operating system(s) such as Linux, UNIX, Microsoft Windows, MacOS, iOS, Android, etc. Still further, the invention could be embodied as a customized hardware component such as a field-programmable gate array (“FPGA”), application-specific integrated circuit (“ASIC”), embedded system, or other customized hardware component without departing from the spirit or scope of the present disclosure.

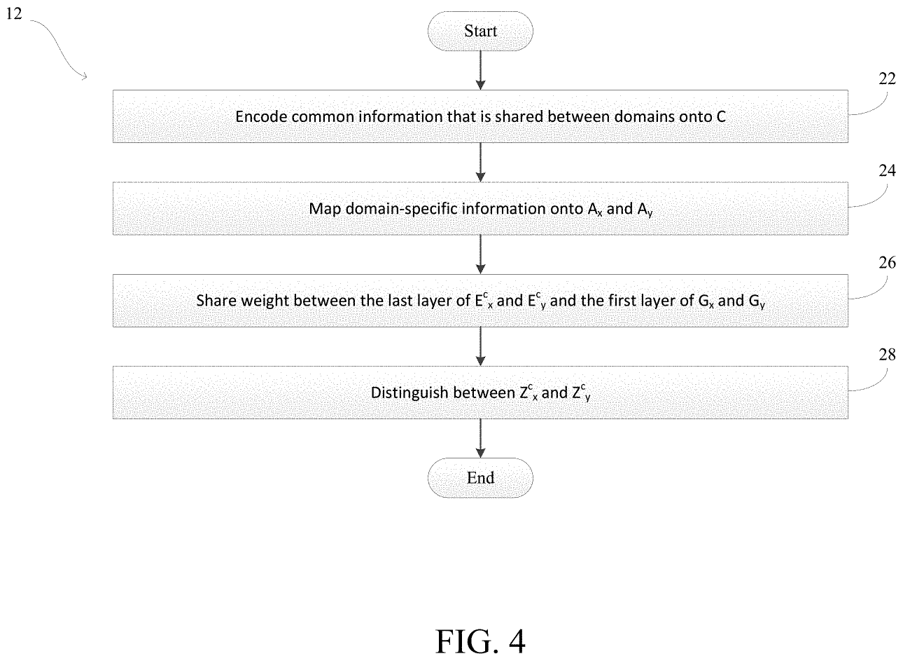

FIG. 4 shows a flowchart illustrating step 12 of FIG. 3 in greater detail. In particular, FIG. 4 illustrates process steps performed during the content disentanglement and attribution processing phase. In step 22, the system, using content encoders, encodes common information that is shared between domains onto C. In step 24, the system, using attribute encoders, maps domain-specific information onto Aₓ and A_{y}. In an example, the system could perform steps 22 and 24 using the following content and attribute formulas:

{zₓ^{c},zₓ^{a}}={Eₓ^{c}(x),Eₓ^{a}(x)} zₓ^{c}∈ [symbol] ,zₓ^{a}∈ [symbol] ₓ

{z_{y}^{c},z_{y}^{a}}={E_{y}^{c}(x),E_{y}^{a}(x)} z_{y}^{c}∈ [symbol] ,z_{y}^{a}∈ [symbol] _{y}

To achieve representation disentanglement, the system applies two strategies. First, in step 26, the system shares a weight between the last neural network layer of E^{c}ₓ and E^{c}_{y} and the first neural network layer of Gₓ and G_{y}. In an example, the sharing is based on the assumption that two domains share a common latent space. It should be understood that, through weight sharing, the system forces the content representation to be mapped onto the same space. However, sharing the same high level mapping functions cannot guarantee the same content representations encode the same information for both domains. Next, in step 28, the system uses a content discriminator D^{c} to distinguish between z^{c}ₓ and z^{c}_{y}. It should be understood that content encoders learn to produce encoded content representations whose domain membership cannot be distinguished by the content discriminator. This is expressed as content adversarial loss via the formula:

L_{adv}^{c}(Eₓ^{c},D^{e})= [symbol] ₓ[½ log D^{c}(Eₓ^{c}(x))+½ log(1−D^{c}(Eₓ^{c}(Eₓ^{e}(x)))]

[symbol]

_{y}[½ log D^{c}(E_{y}^{c}(x))+½ log(1−D^{c}(E_{y}^{c}(E_{y}^{e}(x)))]

It is noted that since the content space is shared, the encoded content representation is interchangeable between two domains. In contrast to cycle consistency constraint (i.e., X to Y to X), which assumes one-to-one mapping between the two domains, a cross-cycle consistency can be used to exploit the disentangled content and attribute representations for cyclic reconstruction. Using a cross-cycle reconstruction allows the model to train with unpaired data.

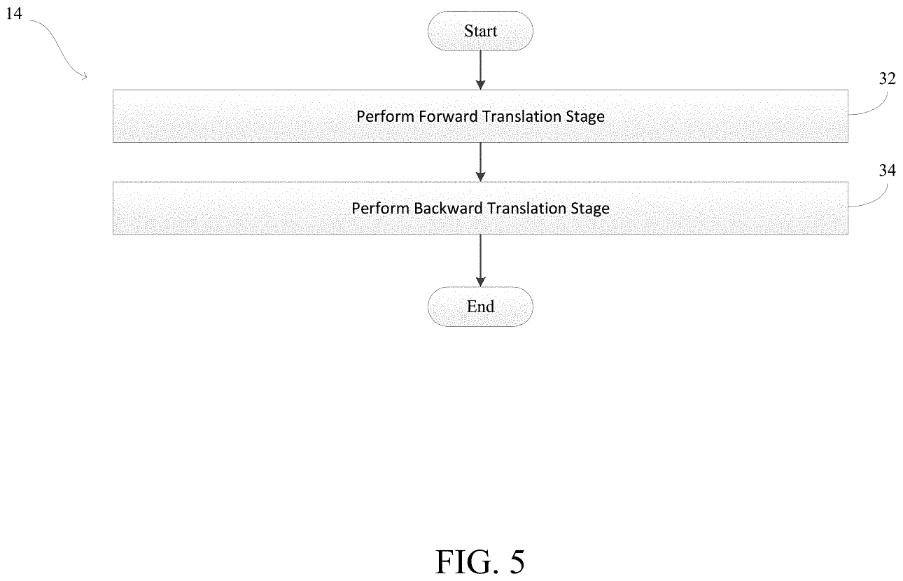

FIG. 5 is a flowchart illustrating step 14 of FIG. 3 in greater detail. In particular, FIG. 5 illustrates process steps performed during the cross-cycle consistency loss processing phase. In step 32, the system performs a forward translation stage. Specifically, given a non-corresponding pair x and y, the system encodes the corresponding pair into {z^{c}ₓ, z^{a}ₓ} and {t_{y}, z^{a}_{y}}. The system then performs a first translation by exchanging the content representation (z^{c}ₓ and z^{c}_{y}) to generate {u, v}, where uϵX, vϵY, and where u and v are expressed via the following formula:

u=Gₓ(z_{y}^{c},zₓ^{a}) v=G_{y}zₓ^{c},z_{y}^{a})

In step 34, the system performs a backward translation stage. Specifically, the system performs a second translation by exchanging the content representation (z^{c}ᵤ and z^{c}ᵥ) via the following formula:

\hat{x}=Gₓ(zᵥ^{c},zₓ^{a}) v=G_{y}zᵤ^{c},zᵤ^{a})

It should be noted that, intuitively, after two stages of image-to-image translation, the cross-cycle should result in the original images. As such, the cross-cycle consistency loss is formulated as:

L₁^{cc}(Gₓ,G_{y},Eₓ^{c},E_{y}^{c},Eₓ^{a}E_{y}^{a})= [symbol] _{x,y}[∥Gₓ(E_{y}^{c}(v),Eₓ^{a}(u))−x∥₁+∥G_{y}(Eₓ^{c}(u),E_{y}^{a}(v))−−y∥₁]

where u=Gₓ(E_{y}^{c}(y)),Eₓ^{a}(x)) and v=G_{y}(Eₓ^{c}(x)),E_{y}^{a}(y)).

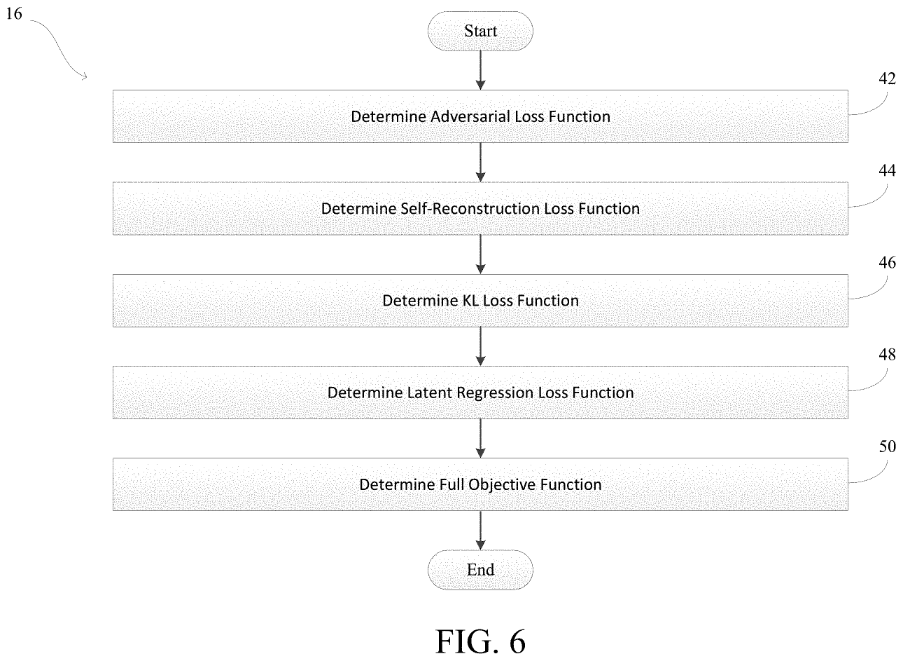

In addition to training the network via the content adversarial loss and the cross-cycle consistency loss, the system can further train the network via other loss functions. In this regard, FIG. 6 is a flowchart illustrating step 16 of FIG. 3 in greater detail. In particular, FIG. 6 illustrates process steps performed during the loss functions processing phase. In step 42, the system determines a domain adversarial loss (“L_{adv}”), where Dₓ and D_{y} discriminate between real images and generated images, while Gₓ and G_{y} generate realistic images. In step 44, the system determines a self-reconstruction loss (“L₁^{rec}”) to facilitate the network training. Specifically, decoders Gₓ and G_{y} decoded the encoded {z^{c}ₓ, z^{a}ₓ} and {z^{c}_{y}, z^{a}_{y}} back to original input x and y using the following formula:

\hat{x}=Gₓ(Eₓ^{c}(x),Eₓ^{a}(x)) and ŷ=G_{y}(E_{y}^{c}(y),E_{y}^{a}(y)).

In step 46, the system determines a Kullback-Leibler (“KL”) divergence loss (“L_{KL}”). It should be understood that the KL divergence loss can bring the attribute representation close to a prior Gaussian distribution, which would aid when performing stochastic sampling at a testing stage. The KL divergence loss can be determined using the following formula:

$${L}_{KL} = 𝔼 [ {D}_{KL} ( ( {z}_{a} ) \vert \vert N ( 0 , 1 ) ) ] , where {D}_{KL} ( p \vert \vert q ) = - \int p ( z ) log \frac{p ( z )}{q ( z )} dz .$$

In step 48, the system determines a latent regression loss L₁^{latent} to fully explore the latent attribute space. Specifically, the system draws a latent vector z from the prior Gaussian distribution as the attribute representation and reconstructs the latent vector z using the following formula:

\hat{z}=Eₓ^{a}(Gₓ(Eₓ^{c}(x),z)) and \hat{z}=E_{y}^{a}(G_{y}(E_{y}^{c}(y),z)).

In step 50, the system 10 determines a full objection function using the loss functions from steps 42-48. To determine the full objection function, the system uses the following formula where hyper-parameters λs control the importance of each term:

$${min}_{G , {E}^{c} , {E}^{a}} {max}_{D , {D}^{c}} {λ}_{adv}^{c} {L}_{adv}^{c} + {λ}_{1}^{cc} {L}_{1}^{cc} + {λ}_{adv} {L}_{adv} + {λ}_{1}^{recon} {L}_{1}^{recon} + {λ}_{1}^{latent} {L}_{1}^{latent} + {λ}_{KL} {L}_{KL}$$

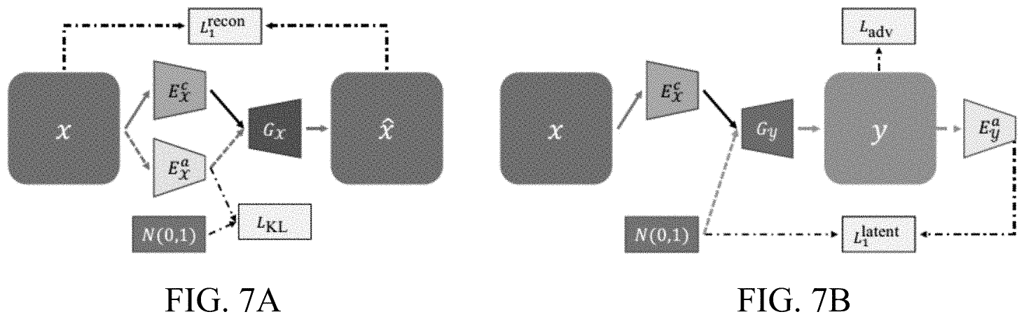

FIGS. 7A and 7B are illustrations showing application of the loss functions of steps 42-48 by the system in the network training process. Specifically, the self-reconstruction loss function L₁^{recon} facilities training with self-reconstruction. The KL loss L_{KL} attempts to align the attribute representation with a prior Gaussian distribution. The adversarial loss L_{adv} encourages G to generate realistic images. The latent regression loss L₁^{latent} enforces the reconstruction on the latent attribute vector.

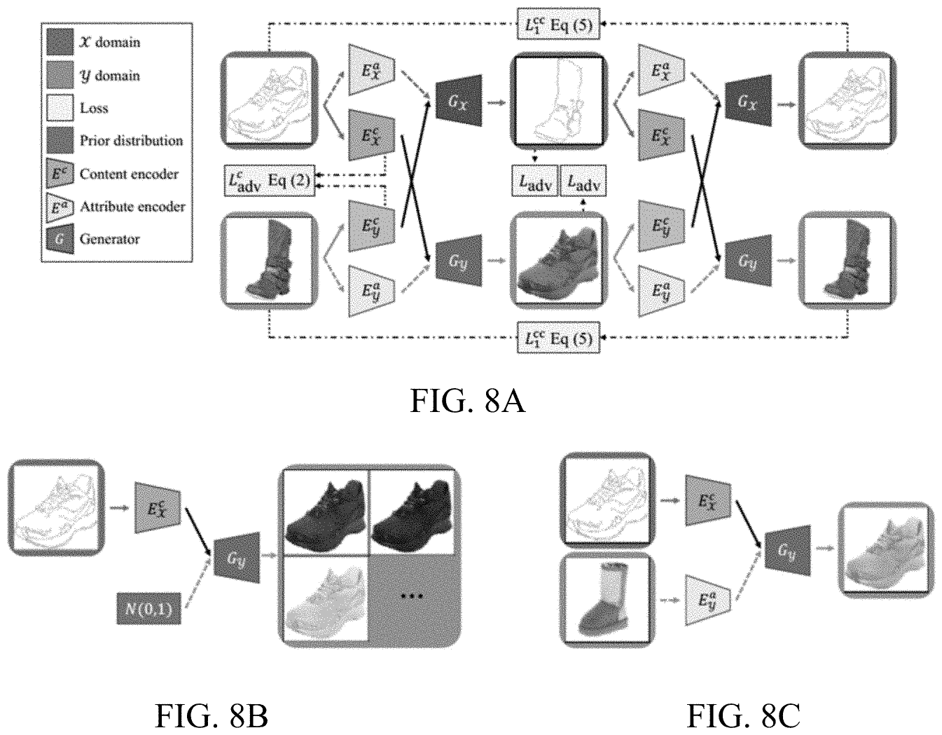

FIG. 8A is a diagram illustrating training by the system using unpaired images to learn a multimodal mapping between two domains X (e.g., X⊂ [symbol] ^{H×W×3}) and Y (e.g., Y⊂ [symbol] ^{H×W×3}) with unpaired data. The training framework includes content encoders {E^{c}ₓ, E^{c}_{y}}, attribute encoders {E^{a}ₓ, E^{a}_{y}}, generators {Gₓ, G_{y}}, domain discriminators {Dₓ, D_{y}} for both domains, and content distributor D^{c}. Using “X” as an example, the content encoder E^{c}ₓ maps images onto a shared content space (E^{c}ₓ: X to C) and the attribute encoder E^{a}ₓ maps images onto a domain-specific attribute space (E^{c}ₓ: X to Aₓ). The generator Gₓ generates images conditioned on both content and attribute vectors (Gₓ:{C, Aₓ to X}). Domain discriminators Dₓ discriminate between real images and translated images. Content discriminator D^{c} is trained to distinguish the extracted content representations between two domains. To enable multimodal generation at test time, the system regularizes the attribute vectors so that they can be drawn from a prior standard Gaussian distribution N(0,1).

FIG. 8B is an illustration showing generation of output images conditioned on random attributes. The training network includes content encoder E^{c}ₓ, a prior standard Gaussian distribution N(0,1), and generator G_{y}. An input image of a edged sneaker is processed through the training network of FIG. 8B to generate output images of different colored sneakers.

FIG. 8C is an illustration showing generation of output images conditioned on a given attribute. The training network includes content encoder E^{c}ₓ, attribute encoder E^{a}_{y}, and generator G_{y}. An input image of a penciled sneaker and a attribute image of a pink boot are processed through the training network of FIG. 8C to generate an output image of a pink sneaker.

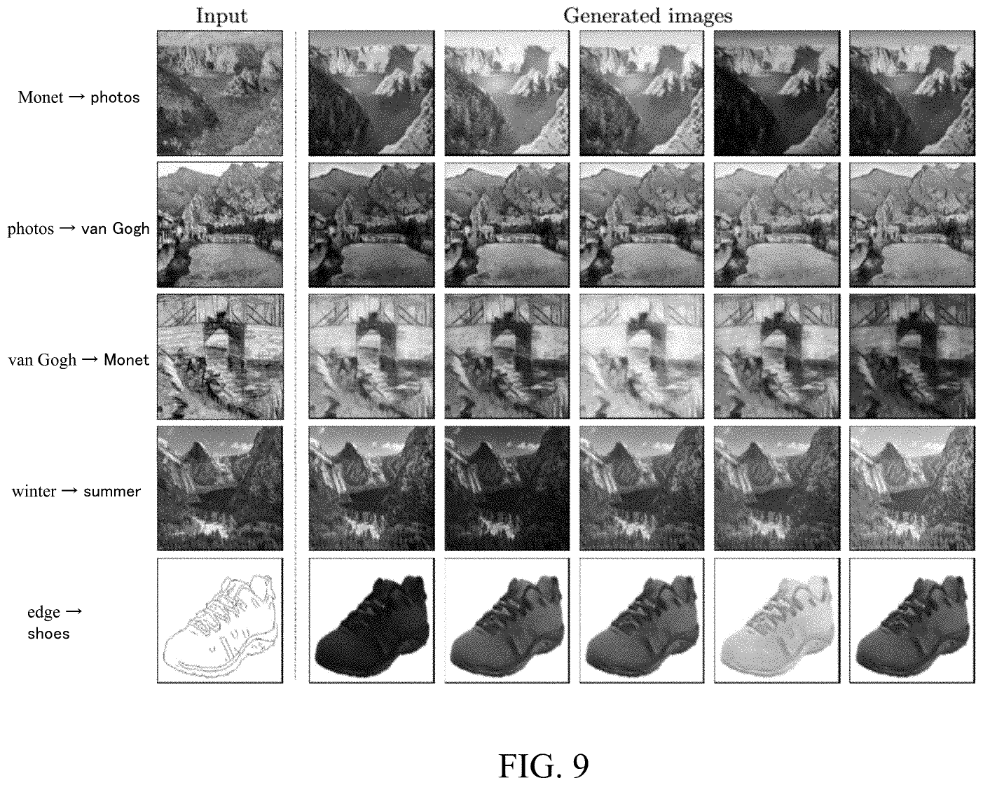

FIG. 9 is an illustration showing sample results produced by the system. Specifically, the left column shows input images in a source domain. The remaining five columns show output images generated by sampling random vectors in the attribute space. The mappings include Monet to photos, photos to van Gogh, van Gogh to Monet, winter to summer, and edge to shoes. Specifically, in the first row, an input image in a Monet style is translated to five output images by sampling random vectors of a real world photo. In the second row, an input image of a lake and mountains is translated to five output images by sampling random vectors of Monet style image. In the third row, an input image in a van Gogh style is translated to five output images by sampling random vectors of a Monet style image. In the fourth row, an input image in a winter setting is translated to five output images by sampling random vectors of an image in a summer setting. In the fifth row, an input image of an edged sneaker is translated to five output images by sampling random vectors of colored images.

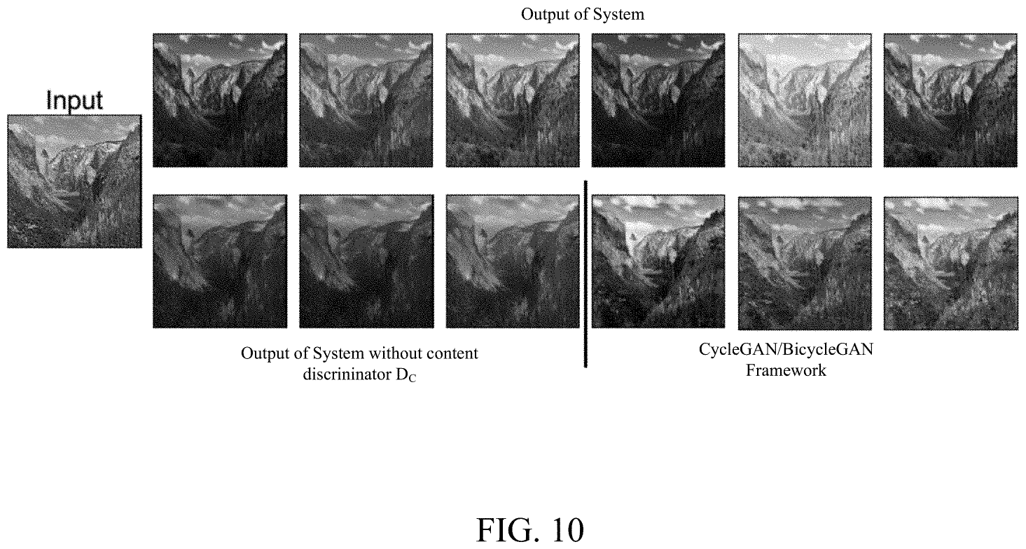

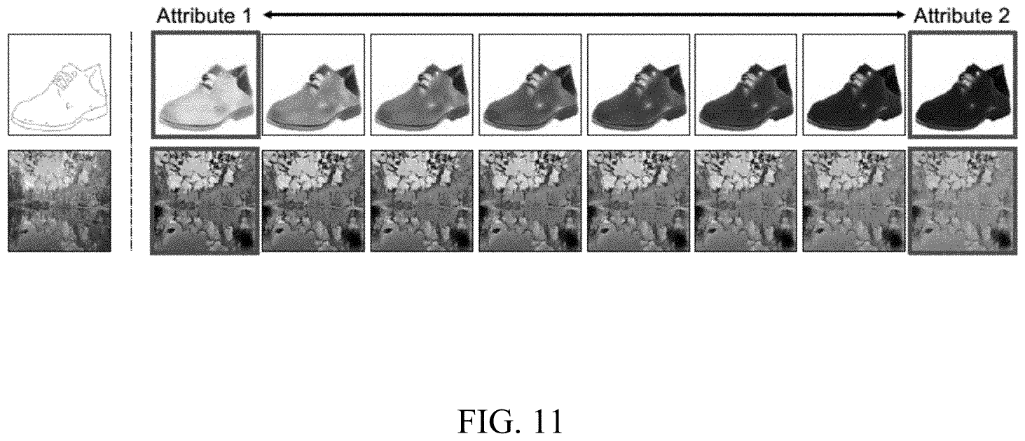

FIG. 10 is an illustration showing a diversity comparison performed on the system. Specifically, in a winter to summer translation, FIG. 10 shows the system producing more diverse and realistic samples (top row) over baselines from the CycleGAN/BicycleGAN system frameworks. FIG. 11 is an illustration showing a linear interpolation of attribute vectors. Specifically, FIG. 11 shows translation results with linear-interpolated attribute vectors between two attributes. Specifically, in the top row, an input image of an edged shoe is translated to where the output image in the attribute 1 column is a shoe in a beige color, the output image in the attribute 2 column is a shoe in a black color, and the images in-between are a linear interpolation of coloring from beige to black. In the bottom row, an input image of a woodland environment is translated to where the output image in the attribute 1 column is a first painting style, the output image in the attribute 2 column is in a second painting style, and the images in-between are a linear interpolation of the two painting styles.

Testing of the above system and methods will now be explained in greater detail. It should be understood that the systems and parameters are discussed below for example purposes only, and that any systems or parameters can be used with the system and methods discussed above. The system can be implemented using a machine learning programing language, such as, for example, PyTorch. An input image size of 216×216 is used, except for domain adaption. For content encoder E^{c}, the system uses a neural network architecture consisting of three convolution layers followed by four residual blocks. For attribute encoder E^{a}, the system uses a convolutional neural network (“CNN”) architecture with four convolution layers followed by fully-connected layers. The size of the attribute vector is |z^{a}|=8. Generator G uses an architecture containing four residual blocks followed by three fractionally strided convolution layers.

For training, the system uses an Adam optimizer with a batch size of 1, learning rate of 0.0001, and a momentum of 0.5 and 0.99. The system 10 sets the hyper-parameters as follows: λc_{adv}=1, λ_{cc}=10, λ_{adv}=1, λ₁^{rec}=10, λ₁^{latent}=10, λ_{KL}=0.01. The system 10 further uses L1 regularization on the content representation with a weight 0.01. The system 10 uses the procedure in DCGAN system for training the model with adversarial loss.

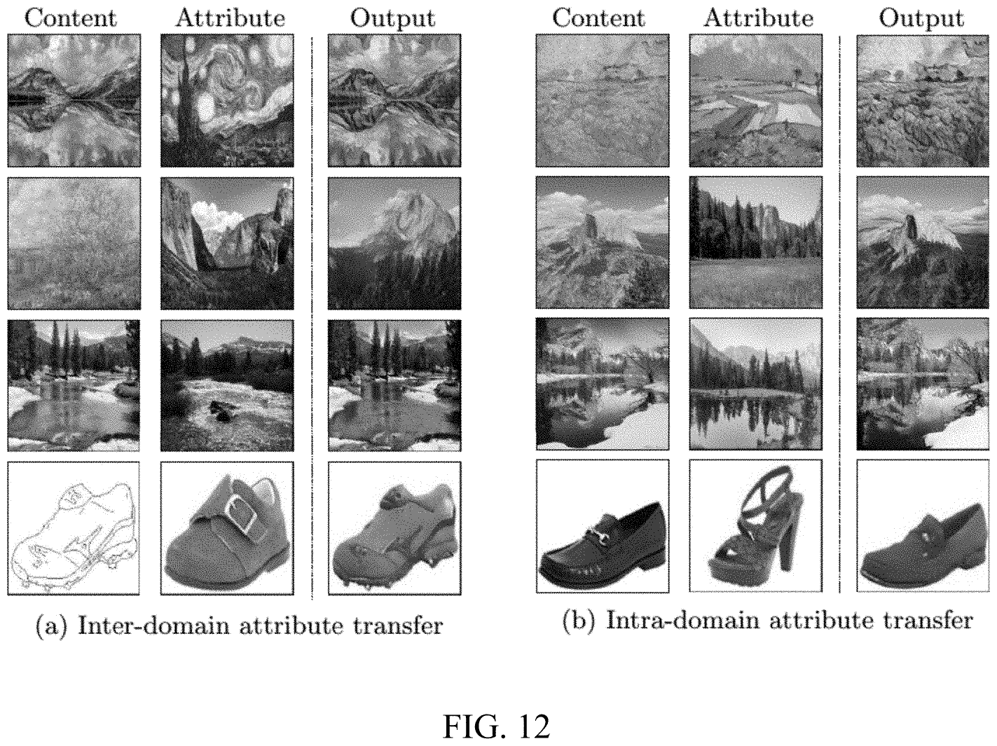

FIG. 12 is an illustration of an attribute transfer process performed by the system using the above parameters performed on several image-to-image datasets. The datasets include Yosemite (summer to winter scenes), artworks (Monet and van Gohn) and edge-to-shoes. The system performs domain adaptation on the classification task with MNIST to MNIST-M, and on the classification and pose estimation tasks with Synthetic Cropped LineMod to Cropped LineMod. It should be noted that in addition to random sampling from the attribute space, the system 10 also performs translation with the given images of desired attributes. Since the content space is shared across domains, inter-domain and intra-domain attribute transfer is achieved.

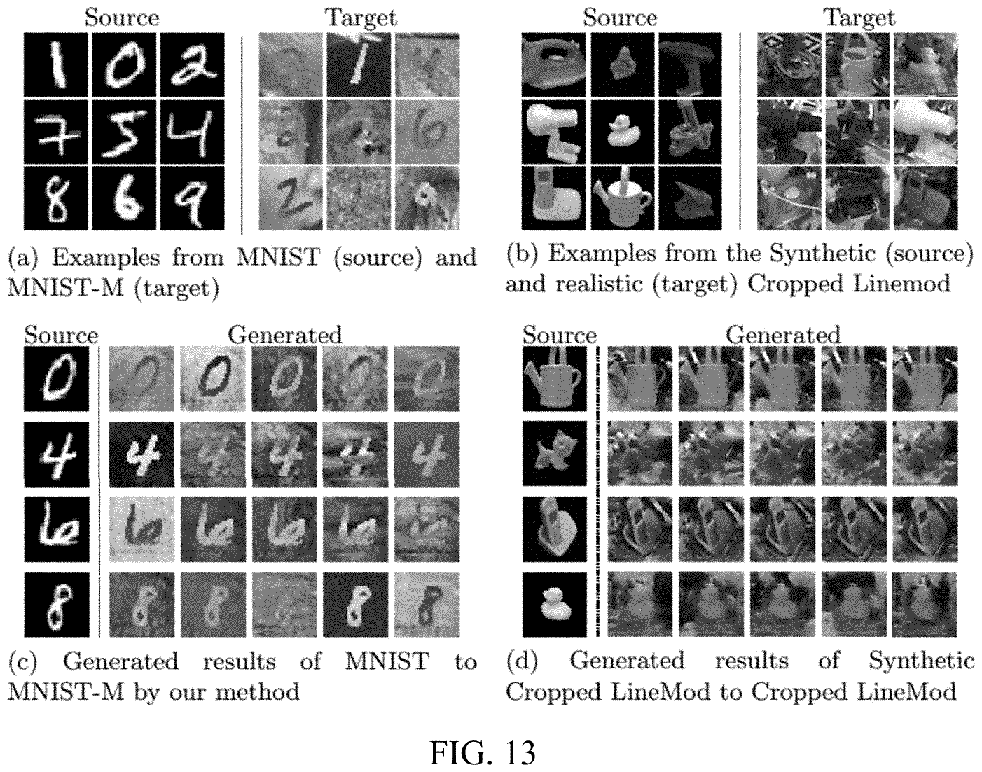

FIG. 13A-13B are illustrations showing domain adaptation experiments performed using the system. Specifically, FIG. 13A shows domain adaptation experiments from MNIST to MNIST-M and Synthetic Cropped LineMod to Cropped LineMod using previous methods. FIG. 13B shows domain adaptation experiments from MNIST to MNIST-M and Synthetic Cropped LineMod to Cropped LineMod using the system and methods of the present invention discussed herein. As can be seen, the system of the present invention generates diverse images that benefit the domain adaptation process.

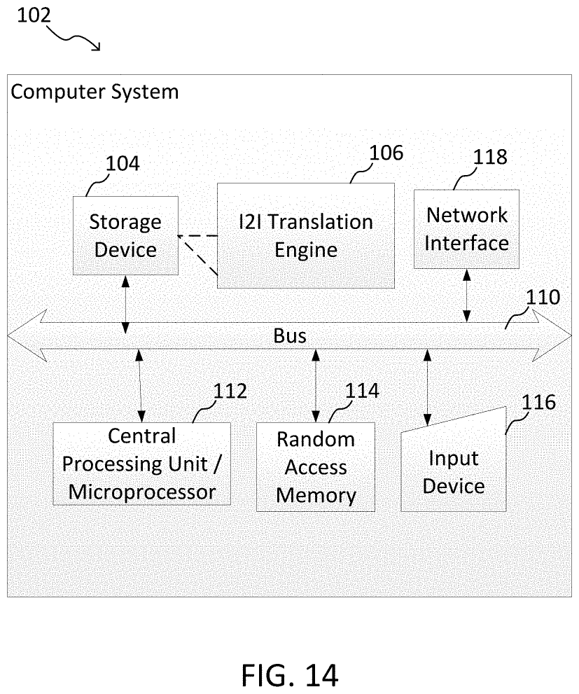

FIG. 14 is a diagram illustrating hardware and software components of a computer system on which the system of the present disclosure could be implemented. The system includes a computer system 102 which could include a storage device 104, a network interface 118, a communications bus 110, a central processing unit (CPU) (microprocessor) 112, a random access memory (RAM) 114, and one or more input devices 116, such as a keyboard, mouse, etc. The computer system 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The computer system 102 could be a networked computer system, a personal computer, a smart phone, tablet computer etc. It is noted that the computer system 102 need not be a networked server, and indeed, could be a stand-alone computer system.

The functionality provided by the system of the present disclosure could be provided by an image-to-image (“I2I”) translation program/engine 106, which could be embodied as computer-readable program code stored on the storage device 104 and executed by the CPU 112 using any suitable, high or low level computing language, such as Python, Java, C, C++, C#, .NET, MATLAB, etc. The network interface 108 could include an Ethernet network interface device, a wireless network interface device, or any other suitable device which permits the server 102 to communicate via the network. The CPU 112 could include any suitable single- or multiple-core microprocessor of any suitable architecture that is capable of implementing and running the I2I translation program/engine 106 (e.g., an Intel microprocessor). The random access memory 114 could include any suitable, high-speed, random access memory typical of most modern computers, such as dynamic RAM (DRAM), etc. The input device 116 could include a microphone for capturing audio/speech signals, for subsequent processing and recognition performed by the engine 106 in accordance with the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A computer vision system for image to image translation, comprising:
a memory; and
a processor in communication with the memory, the processor:
receiving a first input image and a second input image,
applying a content adversarial loss function to the first input image and the second input image to determine a first disentanglement representation of the first input image and a second disentanglement representation of the second input image, and
training a network to generate at least one output image by applying a cross cycle consistency loss function to each of the first disentanglement representation and the second disentanglement representation to perform multimodal mapping between the first input image and the second input image.

2. The system of claim 1, wherein the first input image and the second input image are unpaired images.

3. The system of claim 1, wherein the network is a generative adversarial network.

4. The system of claim 1, wherein the processor determines the first disentanglement representation and the second disentanglement representation by:
utilizing a first input image content encoder to encode content of the first input image into a domain-invariant content space and a second input image content encoder to encode content of the second input image into the domain-invariant content space, the first input image encoded content and the second input image encoded content being indicative of common information between the first input image and the second input image,
utilizing a first input image attribute encoder to encode at least one attribute of the first input image into a first domain specific attribute space and a second input image attribute encoder to encode at least one attribute of the second input image into a second domain specific attribute space,
performing weight sharing between a last layer of the first input image content encoder and a last layer of the second input image content encoder and a first layer of a first input image generator and a first layer of a second input image generator,
utilizing a content discriminator to distinguish between the first input image encoded content and the second input image encoded content, and
applying the content adversarial loss function to the first input image content encoder, the second input image content encoder and the content discriminator.

5. The system of claim 4, wherein the processor generates, using the trained network, a first output image based on the first input image encoded content and the second input image at least one encoded attribute, and a second output image based on the second input image encoded content and the first input image at least one encoded attribute.

6. The system of claim 1, wherein the processor applies the cross cycle consistency loss function to each of the first disentanglement representation and the second disentanglement representation by performing a forward translation and a backward translation on each of the first disentanglement representation and the second disentanglement representation.

7. The system of claim 1, wherein the processor trains the network with one or more of a domain adversarial loss function, a self-reconstruction loss function, a Kullback-Leibler loss function, or a latent regression loss function.

8. A method for image to image translation by a computer vision system, comprising the steps of:
receiving a first input image and a second input image;
applying a content adversarial loss function to the first input image and the second input image to determine a first disentanglement representation of the first input image and a second disentanglement representation of the second input image; and
training a network to generate at least one output image by applying a cross cycle consistency loss function to each of the first disentanglement representation and the second disentanglement representation to perform multimodal mapping between the first input image and the second input image.

9. The method of claim 8, wherein the first input image and the second input image are unpaired images.

10. The method of claim 8, wherein the network is a generative adversarial network.

11. The method of claim 8, further comprising the steps of determining the first disentanglement representation and the second disentanglement representation by:
utilizing a first input image content encoder to encode content of the first input image into a domain-invariant content space and a second input image content encoder to encode content of the second input image into the domain-invariant content space, the first input image encoded content and the second input image encoded content being indicative of common information between the first input image and the second input image;
utilizing a first input image attribute encoder to encode at least one attribute of the first input image into a first domain specific attribute space and a second input image attribute encoder to encode at least one attribute of the second input image into a second domain specific attribute space;
performing weight sharing between a last layer of the first input image content encoder and a last layer of the second input image content encoder and a first layer of a first input image generator and a first layer of a second input image generator;
utilizing a content discriminator to distinguish between the first input image encoded content and the second input image encoded content; and
applying the content adversarial loss function to the first input image content encoder, the second input image content encoder and the content discriminator.

12. The method of claim 11, further comprising the step of generating, using the trained network, a first output image based on the first input image encoded content and the second input image at least one encoded attribute, and a second output image based on the second input image encoded content and the first input image at least one encoded attribute.

13. The method of claim 8, further comprising the step of applying the cross cycle consistency loss function to each of the first disentanglement representation and the second disentanglement representation by performing a forward translation and a backward translation on each of the first disentanglement representation and the second disentanglement representation.

14. The method of claim 8, further comprising the step of training the network with one or more of a domain adversarial loss function, a self-reconstruction loss function, a Kullback-Leibler loss function, or a latent regression loss function.

15. A non-transitory computer readable medium having instructions stored thereon for image to image translation by a computer vision system, comprising the steps of:
receiving a first input image and a second input image;
applying a content adversarial loss function to the first input image and the second input image to determine a first disentanglement representation of the first input image and a second disentanglement representation of the second input image; and
training a network to generate at least one output image by applying a cross cycle consistency loss function to each of the first disentanglement representation and the second disentanglement representation to perform multimodal mapping between the first input image and the second input image.

16. The non-transitory computer readable medium of claim 15, wherein
the first input image and the second input image are unpaired images, and
the network is a generative adversarial network.

17. The non-transitory computer readable medium of claim 15, further comprising the steps of determining the first disentanglement representation and the second disentanglement representation by:
utilizing a first input image content encoder to encode content of the first input image into a domain-invariant content space and a second input image content encoder to encode content of the second input image into the domain-invariant content space, the first input image encoded content and the second input image encoded content being indicative of common information between the first input image and the second input image;
utilizing a first input image attribute encoder to encode at least one attribute of the first input image into a first domain specific attribute space and a second input image attribute encoder to encode at least one attribute of the second input image into a second domain specific attribute space;
performing weight sharing between a last layer of the first input image content encoder and a last layer of the second input image content encoder and a first layer of a first input image generator and a first layer of a second input image generator;
utilizing a content discriminator to distinguish between the first input image encoded content and the second input image encoded content; and
applying the content adversarial loss function to the first input image content encoder, the second input image content encoder and the content discriminator.

18. The non-transitory computer readable medium of claim 17, further comprising the step of generating, using the trained network, a first output image based on the first input image encoded content and the second input image at least one encoded attribute, and a second output image based on the second input image encoded content and the first input image at least one encoded attribute.

19. The non-transitory computer readable medium of claim 15, further comprising the step of applying the cross cycle consistency loss function to each of the first disentanglement representation and the second disentanglement representation by performing a forward translation and a backward translation on each of the first disentanglement representation and the second disentanglement representation.

20. The non-transitory computer readable medium of claim 15, further comprising the step of training the network with one or more of a domain adversarial loss function, a self-reconstruction loss function, a Kullback-Leibler loss function, or a latent regression loss function.
